(19) United States
(12) Patent Application Publication
(10) Pub. No.: US 2002/0099800 A1
(43) Pub. Date: Jul. 25, 2002

(54) Data mark and recall system and method for a data stream

(76) Inventors: Robert Brainard, Scottsdale, AZ (US); Dave Kostelich, Scottsdale, AZ (US)

Correspondence Address: Damon L. Boyd, Snell & Wilmer L.L.P., One Arizona Center, 400 East Van Buren, Phoenix, AZ, 85004-2202, US

(21) Appl. No.: 09/975,433

(22) Filed: Oct. 11, 2001

Related U.S. Application Data
(60) Provisional application No. 60/253,316, filed on Nov. 27, 2000.
(60) Provisional application No. 60/250,103, filed on Nov. 28, 2000.

(51) Int. Cl. G06F 15/16; H04N 7/173

(52) U.S. Cl. 709/219; 725/89

(57) ABSTRACT

In accordance with one aspect of the present invention, an interactive data identification and recall system is provided which avoids the need to encode additional data into the real-time media broadcast stream/system. In addition, the system can eliminate the need to store the entire show on an end user device, such as an ITV, digital TV, HDTV, smart set-top box or other appliance, and it affords the end user a way to continue watching a show uninterrupted and yet at some later time, recall data corresponding to a scene that interested them.

In accordance with another aspect of the present invention, the system allows manufacturers of end user devices and related software systems to significantly streamline their devices so that, with the exception of the delivered content, little or no additional data is actually transmitted in the broadcast, or stored on the end user device, as opposed to present systems that encode data in the real-time video stream, a process which requires a large amount of data be encoded, transmitted, processed and possibly stored regardless of whether or not the end user is interested in the additional data.

### CROSS-REFERENCE TO RELATED APPLICATIONS

This utility patent application claims priority to U.S. Provisional Application No. 60/253,316, filed Nov. 27, 2000 and U.S. Provisional Application No. 60/250,103, filed Nov. 28, 2000.

### FIELD OF THE INVENTION

The present invention relates to interactive data communications, and more particularly, to a method and system for identifying and recalling data relating to a subsection of streaming data, such as television broadcasts (analog and digital), satellite broadcasts, Internet Broadcasts, or digital video program broadcasts (e.g. MPEG-4) and the like for later recall and interactivity.

### BACKGROUND OF THE INVENTION

The available choices for content sources such as cable, satellite and broadcast television as well as Internet broadcasts and Digital Video (e.g. MPEG-4) and other like programming continues to increase rapidly, with the addition of many specialty channels dedicated to such topics as travel, history, sports, homes, news, shopping and music to name a few. In addition to the number of television shows available, a great deal of attention is being directed to the providing of enhanced and interactive programming features to those programs, such as by way of the Internet, the addition of enhanced features to existing broadcast signals, or other communication networks. For example, ABC television offers its end users of its Monday Night Football games an interactive segment by way of the Internet to track the statistics of the game as it progresses, as well as receive additional articles and commentary surrounding the broadcast. In addition, many digital cable and direct satellite television programs offer end users specially configured end user guides which can provide, among other features, listings of program times and stations, narratives summarizing the program, and reminder features. While on many occasions the enhanced and interactive features are provided by the entity providing the original broadcast, it is also becoming more common for third parties to provide these interactive segments.

To facilitate the integration and coordination of the activities surrounding enhanced features, the Advanced Television Enhancement Forum (ATVEF) has been created among a cross-industry alliance of companies representing the broadcast and cable networks, television transports, end user electronics, Interactive TV (ITV) companies, and PC industries. This alliance of companies has defined protocols for Hypertext Markup Language (HTML)-based enhanced television, which allow content creators to deliver enhanced and interactive programming over all forms of transport (analog, digital, cable, and satellite) to any intelligent receivers. An objective for the ATVEF group is to accelerate the creation and distribution of enhanced television programs so that end users can receive enhanced television programs in the least expensive and most convenient way possible and subsequently have those end users interact with the broadcast content. An additional group of companies are striving to define MPEG-4 as the standard for offering interactive broadcasts. As will be described herein, the present invention applies equally to these and other technologies, thereby offering a way to defer interactivity beyond the point of initial broadcast.

While many inroads have been made with respect to enhanced television programming, various problems exist with current systems that limit the available applications for enhanced programming. For example, existing implementations of “t-commerce” (e-commerce via televisions) systems generally require that additional data be transmitted in real time as part of the broadcast stream, i.e., existing systems integrate interactive data directly into the video stream in a synchronous manner via the ATVEF or MPEG-4 specifications. This feature requires that the network programming entities provide video streams with these additional instructions such that the broadcast stream is modified to accommodate the data in a real-time format. As a result, additional bandwidth for implementation and transmission of this enhanced data is required along with sophisticated receivers to view and interact with the broadcast. In addition, these systems require changes to the network broadcast streams after network studio production so that the network entities can embed content/instructions into the video stream via the ATVEF standard. Further, these systems that utilize the ATVEF standard must be configured for the synchronous addition of content to broadcast and video streams.

In addition, existing systems are often configured to download and store the entire broadcast program onto a local hard disk storage area, a process which consumes a significant portion of the limited capacity of available resources and adds cost to the system, such as the addition of hardware to the end users' cable or direct broadcast receiver or ITV set-top box. This storage of the entire broadcast program is often conducted irrespective of whether the end user subsequently desires to view or otherwise utilize/interact with the stored information.

Moreover, existing systems generally download the broadcast or video program in its entirety or utilize encoded data in a synchronous manner while the end user is viewing the television program. Thus, ITV implementations most often rely on synchronous commands and responses by the user based on data that is contained in and/or integrated into, the real-time video/broadcast stream. This real-time synchronous “user model” requires the user to react to, and interact with, some kind of synchronous interactive feature, such as a “pop up” screen or other type of prompting feature, that tells the user that there is something interactive at this time in the program. This feature is triggered by enhanced instructions that have been integrated into the broadcast, and recognized and interpreted by the intelligent receiver. This user model disrupts the user's entertainment experience as it interrupts the user's viewing of the broadcast show by requiring the end user to respond or interact with the interactive feature provided. If the user fails to interact at the specified time, the feature is oftentimes unavailable later.

Still further, existing systems are generally self-contained in such a manner that any viewer watching the television program must interact with the broadcast on the exact same device that they are viewing the broadcast. Current systems do not facilitate asynchronous recall of the programming through other devices. In other words, the end user watching television must interact with that television broadcast via the television set top box, regardless of whether the ergonomics of television interactivity provided are comfortable to the user (e.g., limited keyboard, mouse, and remote functionality).

Existing systems also provide no way for the end user to recall the interactive broadcast content after the broadcast aired. For example, the end user may record a program for viewing at a later time, and at that later time (hours, days, months, etc.) desire to recall and interact with the enhanced content originally associated with the program. However, with current systems, interactive content is not available other than in the original enhanced broadcast stream. It may be more convenient for the end user to go back and recall/interact with content viewed hours, days or months prior to the original viewing.

Accordingly, a need exists for an improved method and system for facilitating the asynchronous identification and recall of data content from content sources such as television broadcasts, audio, video, or Internet broadcasts, or digital programming and the like to provide a low cost, less complex, and more user friendly model for enhancement of such programming.

### SUMMARY OF THE INVENTION

The method and system of the present invention overcomes many problems of the prior art. In accordance with one aspect of the present invention, an interactive data identification and recall system is provided which avoids the need to encode additional data into the real-time media broadcast stream/system. In addition, the system can eliminate the need to store the entire show on an end user device, such as an ITV, digital TV, HDTV, smart set-top box or other appliance, and it affords the end user a way to continue watching a show uninterrupted and yet at some later time, recall scenes and enhanced data corresponding to the scenes that interested them.

In accordance with another aspect of the present invention, the system allows manufacturers of end user devices and related software systems to significantly streamline their devices so that, with the exception of the delivered content, little or no additional data is actually transmitted in the broadcast, or stored on the end user device, as opposed to present systems that encode data in the real-time video stream, a process which requires a large amount of data be encoded, transmitted, processed and possibly stored regardless of whether or not the end user is interested in the additional data.

In accordance with an exemplary embodiment, a data mark and recall system comprises a client marking system, a client recall system and a content source. The content source comprises any system or device for providing information and data content to end users, such as, for example, a broadcast television signal. The client marking system comprises a system which facilitates client marking of discrete portions and/or further content (e.g., enhanced content) of the content source. The client recall system facilitates recall of the marked discrete portions of the content source and accompanying enhanced data for user interaction. Optionally, the introduction of an intermediary content source database enables system configurations where the content recall system could be the same or separate physical device as the content marking system.

Optionally, the data mark and recall system further comprises an enhanced content source database which can be the enhanced content itself or a database which facilitates storage not only of the enhanced content, but also of the markers only, the markers and the enhanced content or still further the marker, enhanced content and segments of the data stream (i.e., scenes) corresponding to the enhanced content. The enhanced content database comprises a database storage component system configured to suitably facilitate identification and recall of markers and scene data. One skilled in the art will appreciate that the enhanced content database may also be the component which provides enhanced content . A client recall system comprises a system by which the end user can recall and view/interact with the marked scenes along with enhanced content. Thus, the system provides for the recall of the enhanced content in discrete pieces by an end user for later (interactive) use.

For example, in accordance with an exemplary embodiment of the present invention, a scene from a particular program (show) can be suitably “marked” to identify the scene. Upon marking, a marker in the form of a locating packet is suitably stored. The marker may comprise “coordinates” such as channel, date and time, geographic locale, or any other locating means for identifying a particular scene on a particular channel at a particular time in a particular geographic locale for a particular user. Thus, the marker itself can be substantially smaller size than the data which corresponds to that marker. In accordance with another aspect of the present invention, the end user, at a later point in time (if desired), can recall the stored scene by use of the marker, and the client recall system will access the enhanced content database that contains various data corresponding to that scene. For example, the data may include information relating to shopping, services, promotions and coupons, cast and bios, encyclopedia, contests and trivia or any other similar information along with the content scene itself Additionally, the client marking system (e.g., Interactive TV) may be different than the client recall/viewing system (e.g., wireless PDA). Thus, the enhanced data stored can be any information that is of interest to the end user.

### BRIEF DESCRIPTION OF THE DRAWINGS

A more complete understanding of the present invention may be derived by referring to the detailed description and claims when considered in connection with the figures, where like reference numbers refer to similar elements throughout the figures, and:

FIG. 1 is a block diagram of a data mark and recall system in accordance with the present invention;

FIG. 2 is a block diagram of an exemplary embodiment of a data mark and recall system implementation in accordance with the present invention;

FIG. 3 is another alternative embodiment of a data mark and recall system using various in accordance with the present invention;

FIG. 4 is an alternative embodiment of a combined data mark and recall system illustrating implementation of various viewing devices and Interactive TV in accordance with the present invention;

FIG. 5 is an alternative embodiment of an aggregated data mark and recall system illustrating implementation of various marking and viewing devices and Interactive TV with personal computer and internet recall devices in accordance with the present invention; and

FIG. 6 is an alternative embodiment of an aggregated data mark and recall system illustrating implementation of various marking and viewing devices and Interactive TV with wireless remote recall devices in accordance with the present invention.

### DETAILED DESCRIPTION OF EXEMPLARY EMBODIMENTS OF THE INVENTION

The present invention is described in part in terms of functional block components and various processing steps. Such functional blocks may be realized by any number of hardware and/or software components configured to perform the specified functions. For example, various embodiments of the present invention may employ various integrated circuit components, servers, switches, routers, remotes, set-top boxes, analog and digital televisions, and signal processors and the like, which may carry out a variety of functions under the control of one or more microprocessors or other control devices.

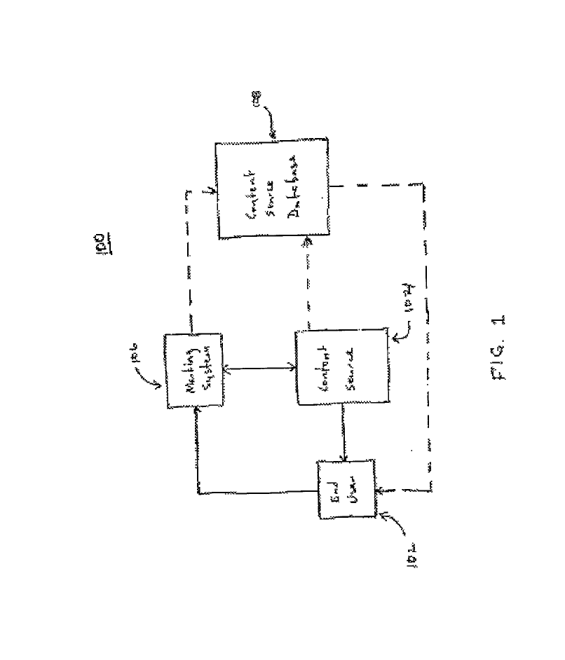

In accordance with the present invention, with reference to FIG. 1, an interactive data identification and recall system 100 comprises an end user 102, a content source 104, a marking system 106 and, a content source database 108. In the present non-limiting exemplary embodiment, end user 102 refers to the person using the system, such as the viewer of content source 104. Content source 104 suitably comprises any system or device(s) for providing information and data content to end users. For example, content source 104 may comprise television broadcasts, such as High-Definition Television (HDTV), Interactive Television (ITV), MPEG-4 broadcasts, digital, analog, or satellite television broadcasts, as well as audio broadcasts or network broadcasts, such as through an Internet Protocol (IP) network. The information and data content can be suitably received by an end user 102 through various sources, such as through HDTV, ITV, digital or analog TV sets, hand-held personal digital assistants (PDA's), or computer interface equipment.

Preliminarily, it should be noted that the various components and structures of the present invention described herein are merely exemplary, and many may be implemented on the same or different devices. In addition, various aspects of the present invention may be practiced in any number of data communication contexts (topologies, architectures, and protocols) used to connect marking system 106, content source database 108, content recall system, and content source 104.

As discussed above, existing systems for providing enhanced broadcast and video programming require the addition of complex integration to the hardware and the broadcast data, such as the integration of additional information into the broadcast stream, and thus require significant additional infrastructure and bandwidth. However, in accordance with various aspects of the present invention, an exemplary method and system can provide asynchronous identification and recall of broadcast data for interactive use by end users, at some later time of the end users choosing, and use minimal additional infrastructure and bandwidth.

Additionally, it should be understood that between content source 104 and marking and recall system 100, the actual distribution of the network video broadcasts or other content sources may be through any number of intermediaries and retransmission points and still fall within the scope of the present invention. For instance, a studio can produce a show, which can be licensed to and broadcast by the networks. This content source may then be transmitted then through MCOs (multi-channel operators) in each metropolitan area and then out through a specific broadcast company. Thus, the actual method of transmission and the number of affiliates and/or network partners involved in delivering of the content is non-limiting. Similarly, content source 108 may also include re-broadcasts (“re-runs”), and content which has been downloaded to a local storage device (such as a DVD, videocassette, or caching Interactive TV Set-Top Box). Further, one might assume that the broadcast content could be delivered to marking system 106 through a number of different broadcast mechanisms and Protocols P1 such as cable transmission, digital cable transmission, satellite TV feed, IP based TV delivery over DSL or other line, or other broadcast mechanisms.

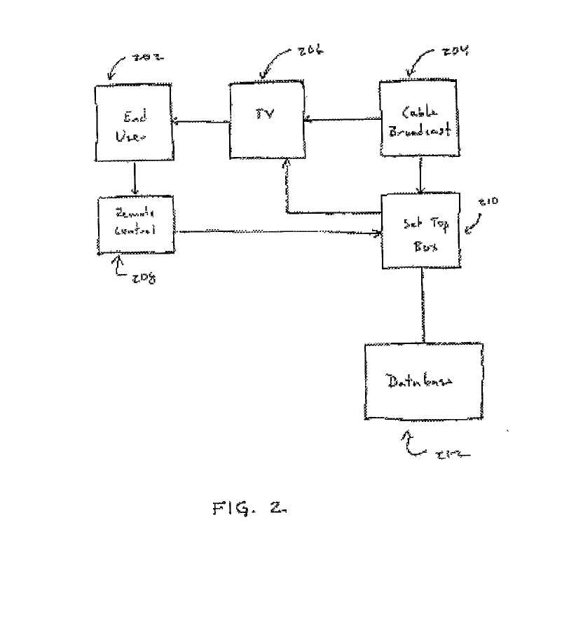

In accordance with further aspects of this embodiment of the present invention, marking system 100 is provided to enable end user 102 to “capture” a location marker which corresponds a “coordinate” defining a subsection of content source 104 to information corresponding to the subsection located in content source database 108 such as, for example, enhanced content. In the present exemplary embodiment, and with reference to FIGS. 1 and 2, upon “marking” the particular scene, in accordance with one aspect of the presently described embodiment, a marker which identifies the “location” of the scene is created. Markers may suitably comprise any data packet which can identify the time, channel and/or other necessary information unique to the scene being viewed by the end user along with the identity of the end user. For example, the location information of the marker may include the channel number, the date the scene was broadcast, the broadcaster and network, the geographic locale and/or the time at which the scene occurred (for example, time offset within the particular show, or as a GMT universal time marker as appropriate). The marker is then stored for asynchronous (later) recall. Thus, in accordance with one aspect of the present invention, each user 102 has a set of their own markers corresponding to the “scenes” in the various broadcasts that they have marked and may subsequently want to recall. For example, in accordance with one exemplary embodiment of the present invention, the marker may be stored on a storage medium suitably located in a set top box 210 provided for in the presently described system.

In accordance with the present invention and as generally described herein, the various components and processes communicate by various communication connections and protocols (P1, P2, P3, P4). Various communications architectures, protocols, and methods may be used to connect the various components and/or process blocks of the present invention, such as marker system and content database. For example, methods and combinations of methods, include, but are not limited to: Cable TV, Analog Phone Line, Digital Cable TV, Wireless RF, Satellite TV, Internet (via TCP/IP, HTTP and the like), Web TV (IP Broadcasts) and the like. Stated otherwise, the particular communications infrastructure used to connect various components of system 100 mentioned herein are merely non-limiting exemplary connections. Further, in accordance with various aspects of the present invention, one skilled in the art will also realize that it may be possible for the system 100 to use multiple communications channels to operate (e.g., and ITV system receiving analog TV broadcasting, and using an analog phone line for upstream communications of markers and system functions).

Data mark and recall system 100 provides the ability to end users or viewers to receive information, data or programs provided by content source 104 and suitably identify information for asynchronous recall and interactive use. For example, with continuing reference to FIG. 1, end user 102 suitably views information or programming received from broadcast data source 104, such as the content sources described above. From the information in broadcast data source 104, selected data content can be suitably marked by marking system 106 at the command of end user 102 through various devices, such as the end user's interface device, to broadcast data source 104. Examples include, remote controls, computer interface devices such as a keyboard and mouse, or even via wireless devices such as phones or PDAs. Thus, as described above, user 102 is able to create a marker and suitably store that marker.

Optionally, content source database 108 comprises a database suitable for storing information relating to content source 104 along with any additional enhanced/interactive data that needs to be stored along with the content source data. In the present exemplary embodiment, content source database 108 may include data relating to content source 104 at various points, times and locations including information relating to shopping, services, promotions and coupons, cast and bios, encyclopedia or other such information that may be tied to particular scenes of the broadcast. Such information will be referred to herein as “enhanced content” and in that regard, generally means information which relate in some way to the scene, but provides information which may not be readily gleaned from the scene itself.

In accordance with the presently described embodiment, the storage means of content source database 108 is provided in the form of hard-disk storage (magnetic), but may likewise comprise any other now known or as yet unknown storage means such as, for example, optical disk, magnetic tape, flash memory, various digital storage means and the like. Additionally, in accordance with the presently described embodiment and as mentioned above, content source database 108 is remotely located from end user 102 and marking system 106. However, it should be appreciated that content source database 108 (or any other component of the present invention) need not be located remotely, but rather, may be incorporated into local servers and appliances which perform the same functions described herein. For example, content source database 108 and marking system 106 may be implemented in the same device/enclosure such as the case where content source database 108 comprises media such as DVDs, VHS or other local media.

In accordance with various additional aspects of the present invention, marking and recall system 100 may store markers to content source database 108, and do so at such time that user 102 initiates a marker. Alternatively, marking system 100 may cache a set of markers for later transmission to, and storage on, content source database 108 and marking system 100 and in such case may suitably send the entire group of markers to content source database 108 at one time. Thus, marking system 100 may transmit data/scene markers to content source database 102 either synchronously or asynchronously. Still further, database 108 may comprise not only markers, but also scene and any additional desired enhanced information.

In accordance with various embodiments, after storing the marker, end user 102 is suitably capable of recalling the various stored markers and selecting a marker corresponding to a particular content source subsection via marking system 106. Marking system 106 then accesses content source database 108 in order to present to end user 102 data corresponding to that content source subsection. In these exemplary embodiments, upon recall of the marker, set top box 210 accesses content source database 212 which contains various information corresponding to the previously viewed scene(s) identified by the marker. End user 102 is also suitably capable of viewing their list of stored markers, and subsequently managing that set of markers to perform various functions (delete markers, edit markers, recall list of markers, and the like).

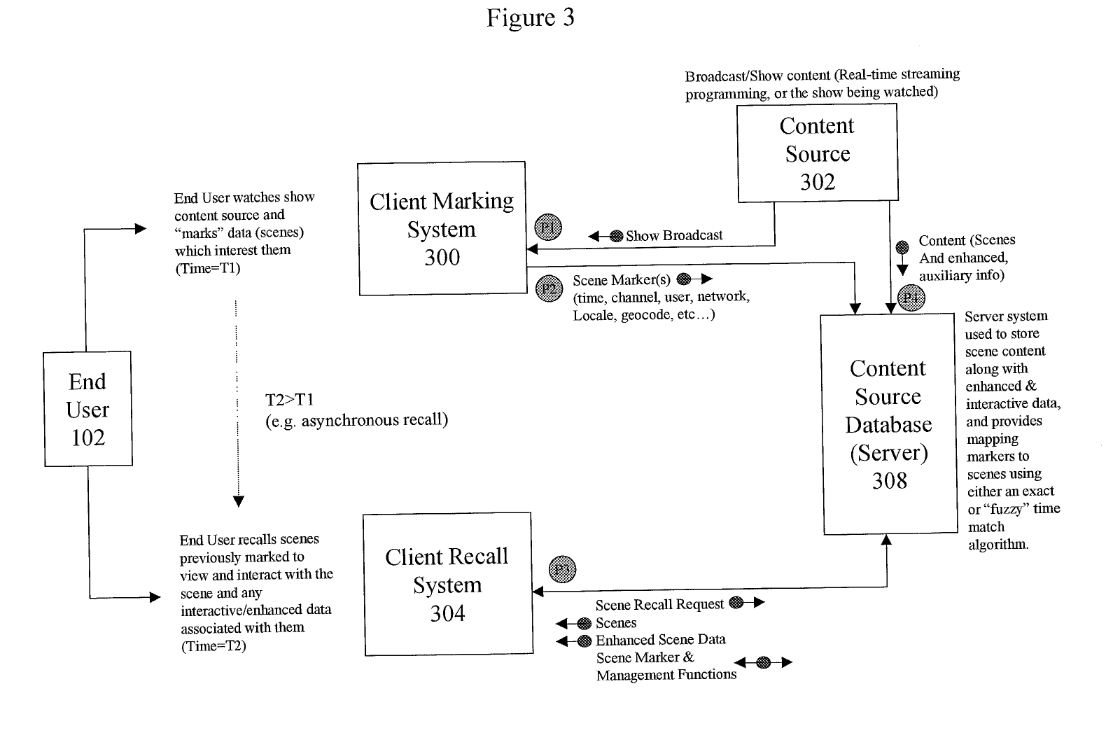

With reference now to FIG. 3, an exemplary embodiment of the data mark and recall system 100 is illustrated. Generally, system 100 comprises end user broadcast viewing and marking device 300. This is where end user 102 watches the original broadcast show content from content source 302 and where they “mark” data (scenes) which interests them. Marking system 300 can be comprised as a set top box or any other device suitably capable of recognizing content source 302 and capturing and storing a marker corresponding to a subsection of content source 302 such as a particular scene in a broadcast signal. Marking system 300 may be any device which provides a suitable means of viewing broadcasts and allowing the end user to specify which data/scenes they want to mark, such as an Interactive Television, personal computer, personal digital assistant (PDA) or any other suitable device.

In accordance with another aspect of the present embodiment, a client recall system 304 is provided as a component of system 100. Recall system 304 suitably allows end user to recall scenes previously marked, to view and interact with those scenes and any enhanced/interactive data associated with those scenes. Recall system 304 may be any device which provides a suitable means of recalling and displaying scene information, such as an Interactive TV, Internet connected PC, cell phone, wireless PDA HDTV or any other suitable device.

In accordance with still another aspect of the present embodiment, content source database 308 is provided as a suitable back-end database implementation as a server (e.g., SQL database with scene content and marker mapping systems). Database 308 suitably stores scene content along with enhanced/interactive data, and provides for mapping data/scene markers to scenes using either exact or “fuzzy” time matching.

In accordance with an exemplary embodiment of the present invention and with reference to FIGS. 2, system 100 may be implemented as described herein. End user or viewer 202 views a broadcast show, such as a television show which is part of a cable broadcast 204 provided to a television 206 equipped with the present invention. When end user 202 sees an item of interest in a particular scene, end user 202 uses a remote control to suitably “mark” the scene of interest. Remote control is preferably a wireless or infrared remote such as a standard TV remote control, but likewise may include a stand-alone remote control of particular use for system 100 or likewise may comprise VCR, DVD, or other set-top box remote controls and the like. Thus, at a later point in time following the initial broadcast of the particular scene, end user 202 may recall the stored marker corresponding to the previously reviewed scene.

Thus, one skilled in the art will recognize that the illustrative markers described herein are of substantially smaller size than the information associated with those markers. Additionally, the markers may be compressed and/or encrypted in order to secure and optimize transmission to/from the content source database.

In accordance with an exemplary implementation and various aspects of the present invention, Table 3 illustrates a scene marker record corresponding to a content source database and is used to mark a scene for later retrieval. A separate user, scene, network, and show table may be used to correlate this information to scenes. However, one skilled in the art will recognize that various fields other than those described herein may also be implemented and still fall within the ambit of the present invention. Further, any algorithm for combining the fields in a determinable fashion to encrypt them into a single code that can be decrypted without losing information may be utilized to generate the scene marker.

TABLE 3
Data/Scene Marker Table

| Field | Type | Description |
|---|---|---|
| MarkerID | Int | (unique identifier of this marker) |
| UserID | Int | (unique identifier of the end user) |
| MarkerDateTime | DateTime | (time of this Marker ID - e.g., GMT, local |
| | | time, channel date) |
| MCOID | Varchar | (unique identifier of broadcasting |
| | | operator - e.g., COX, DirectTV, etc) |
| ChannelID | Varchar | (unique identifier of this network channel - |
| | | e.g., CBS, FOX, etc.) |
| GeoCode | Varchar | (unique identifier of this users geographic |
| | | position) |
| ShowID | Varchar | (unique identifier of show and episode |
| | | being seen, If known, e.g. “60 Minutes”, |
| | | Frasier - Episode 18”, etc.) |

In accordance with a further aspect of an implementation of the present invention, Table 4 illustrates an exemplary scene table which may be used to map scene markers to scenes for later retrieval. As described earlier, separate user, scene, network, and show tables may be used to correlate information to particular scenes. However, one skilled in the art will appreciate that many alternative fields could be stored in the scene table. Further, any algorithm for combining the fields in a determinable fashion to encrypt them into a single code that can be decrypted without losing information could be utilized to generate the scene table. Additionally, again, various possible implementations for storing the date and time fields, such as in GMT or local time, and various conversions may also be implemented.

TABLE 4
Scene Table

| Field | Type | Description |
|---|---|---|
| SceneID | int | |
| ShowID | int | (unique identifier of the scene and specific |
| | | episode for the scene) |
| SceneGraphic | Varchar | (pointer to graphic of this scene, or |
| | | embedded binary graphic BLOB data file |
| | | stored here) |
| SceneTime | int | (hh:mm:ss from show start) |
| SceneWidth | int | (width of scene in pixels) |
| SceneHeight | int | (height of scene in pixels) |
| SceneFormat | Varchar | (type of graphic, e.g. GIF, JPEG, TIF, |
| | | BMP, PCX, etc) |
| SceneRelatedCont | (various) | Additional enhanced feature information |
| | | about this particular scene (e.g. list of |
| | | shopping objects, list of actors on the |
| | | scene, etc). This field could be a key into |
| | | auxiliary tables and/or databases to cross |
| | | reference this scene with such enhanced |
| | | content. |

One skilled in the art will also recognize that the scenes (graphics) being recalled for display on the end user may need to be formatted to fit the viewing device appropriately. For instance, the end user may have been watching the show on a HDTV with 720 p (1280×720 pixels progressive scan) or 1080: (1920×1080 pixels interlaced scan) resolution, but then wishes to later recall the marked scene from that show viewing on a handheld PDA with only 512×256 resolution. Various formats and alterations of the scene may be provided to enable viewing, and this patent does not specify any particular criteria there, and should apply regardless of the conversions, compressions, and encryptions applied. The recall action itself may consist of sending a scene to the end viewing device (TV, PC, PDA, etc.) from the content source database. Preferably the scene stills representing one frame of the network broadcast content are sent in some form of a compressed graphic format such as a GIF or JPEG.

In accordance with various aspects of the present invention, the marked scene can be transmitted to the end user in a number of different formats. For example, the scenes could be sent to the end user either discretely one at a time, or various optimizations such as group and compression (e.g., creating a ZIP file of all scenes to be sent) could be applied if it assists with efficient transmission.

The content of the returned scenes can also contain many types of information, and additional markup information based on the system of implementation. This additional scene information could be HTML markup maps of the scene, object maps, and other such information. One skilled in the art will recognize that the present invention contemplates accompanying scene content delivered in addition to the actual scene content itself, through the specific mechanism of providing this data, transmitting it, encoding it, encrypting it, and the like.

Additionally, in accordance with various aspects of the present invention, the method that content source database 108, 308 uses for mapping a marker to an appropriate scene can be either exact or “fuzzy”. If exact, then only the scene within the broadcast that has the exact time match to the marker shall be returned. If “fuzzy”, nearby scenes might be sent to the end user viewing device when a specific scene is recalled if no exact match to their time marker can be found in the broadcast stream. Consequently, in accordance with another aspect of the present invention, the various markers need not be an exact match for a specific scene of a show, but a close or nearby scene can be returned as a match. The degree of this time-marker-to-scene match could be vendor implementation specific, and even broadcast and show specific, and could vary from hundredths of a second to multiple seconds. Thus, this invention is not limited by only returning exact matches for markers as “fuzzy” match implementations can be envisioned which return nearby useful scene information to the end user.

Additionally, the end user may wish to view scenes which are a period of time (e.g., 5-10 seconds) in front and/or behind the saved scene marker so that the end user can browse forwards and backwards in the show and view additional scenes which are related to the one the end user has marked; the content source database and content recall system implementations would likely provide those accompanying features.

In the present exemplary embodiment, after marked scene recall, the end user may interact with the scene in various manners and for various purposes (applications). For example, a cursor may be moved over the scene, highlighting interactive content when the cursor touches the interactive item. When clicked upon, highlighted items suitably recall information about the item from the content source database. At that point, the user may then be presented options, such as purchasing that item.

As mentioned above, in an exemplary embodiment of the present invention, when the end user chooses to recall a specific scene in accordance with the present invention, the end user can suitably browse and view a list of the scenes which they have marked/saved. For example, such list may be displayed by reviewing the content source database according to the markers that have been reported for this particular end user and then returning a list of the scenes to the end user so the end user can browse the list of their saved scenes, and then pick one for recall to interact with that scene.

As briefly mentioned above, in accordance with various aspects of the present invention, scene “information” may be stored in content source database 108, 308 in many different formats and alternate implementations. For example, an alternative implementation to the above table scheme would be to store raw video streams or MPEG-4 streams for all shows in the database. Thus, for encoded video streams, the database could translate a scene marker into a show scene by doing a lookup in the show video at the appropriate time, extracting the appropriate frame, converting it to an acceptable graphics format for transmission and display to the end user device, and then return to the scene. This exemplifies that the content source database may be kept, maintained, and stored in many different implementations, a relational database being one exemplary example.

In accordance with the present invention, a toolkit may also be provided allowing the networks and other content source providers to encode the various scene information for storage into the content source database 102.

In accordance with still of further aspect of the present invention, multiple graphics may be stored for the same scene. For example, based on Motion Picture Association (MPAA) ratings, depending on the age of the end user, a G rated version of the scene could be returned for a younger end user, or a PG rated version could be returned for an older end user.

In accordance with yet another aspect of the present invention, this system can also be designed to handle multiple customer accounts, where each customer is identified by a set of unique characteristics (e.g., login id, password, etc.). Multiple accounts per household may also be handled by the system without limiting the application of the data mark and recall system. Furthermore, login and system access can be done in many forms and implementations. Regardless of the method of user login, access, identification, security, and management, the data mark and recall system can be constructed successfully.

### SPECIFIC NON-LIMITING ILLUSTRATIVE EMBODIMENTS

The following descriptions and references to the various drawing figures are merely illustrative examples of preferable embodiments of the present invention. That being said:

With reference to FIG. 3, client marking system 100 is provided to an end user 102 as a broadcast viewing and marking device. In accordance with one aspect of the present invention, system 100 suitably allows end user 102 to view original broadcast content streams and suitably mark data (scenes) which interest them for any reason. Client marking system 100 can be comprised as any device (for example, set top boxes or other home entertainment devices and the like) or any other device suitably capable of recognizing a content source 302 and preferably capturing and storing a marker corresponding to a subsection of content source 302 such as a particular scene in a broadcast signal.

With further reference to FIG. 3, in accordance with various aspects of the present exemplary embodiment, client marking system 100 may be any device which provides a suitable means of viewing broadcasts and allowing the end user to specify which data/scenes they want to mark, such as an Interactive Television, personal computer, personal digital assistant (PDA) or other suitable information displaying device.

Additionally, in accordance with various aspects of the present exemplary embodiment, a client recall system 101 is provided to suitably facilitate end user 102 content 300 recall and/or viewing. For example, in the present embodiment, recall system 304 allows end user 102 to recall broadcast scenes previously marked, and preferably, to interact with those scenes as well as any interactive data associated with those scenes. Client recall system 304 is any suitable device which provides a means of recalling and displaying scene information. For example, in accordance with various embodiments of the present invention, recall system 304 might be an Interactive TV, Internet connected PC, cell phone, wireless PDA, HDTV, or any other suitable device.

In accordance with further aspects of the present exemplary embodiment, content source database 308 may be provided. Preferably, database 308 is a back-end database implementation as the server (e.g. SQL database with scene content and marker mapping systems). Optionally, recall system 304 may be used to store scene content along with enhanced/interactive data, and further still, may provide for mapping data/scene markers to scenes using either exact or, as described above, using “fuzzy” time matching.

As mentioned above, and with continued reference to FIG. 3, content source 302 is provided as any system or device for providing or comprises streaming information and data content to end users. In the present illustrative embodiment, content source 302 comprises streaming broadcast show content (programming) being watched by end user 102, though one should appreciate that any other streaming content such as those previously described herein may likewise be content source 302.

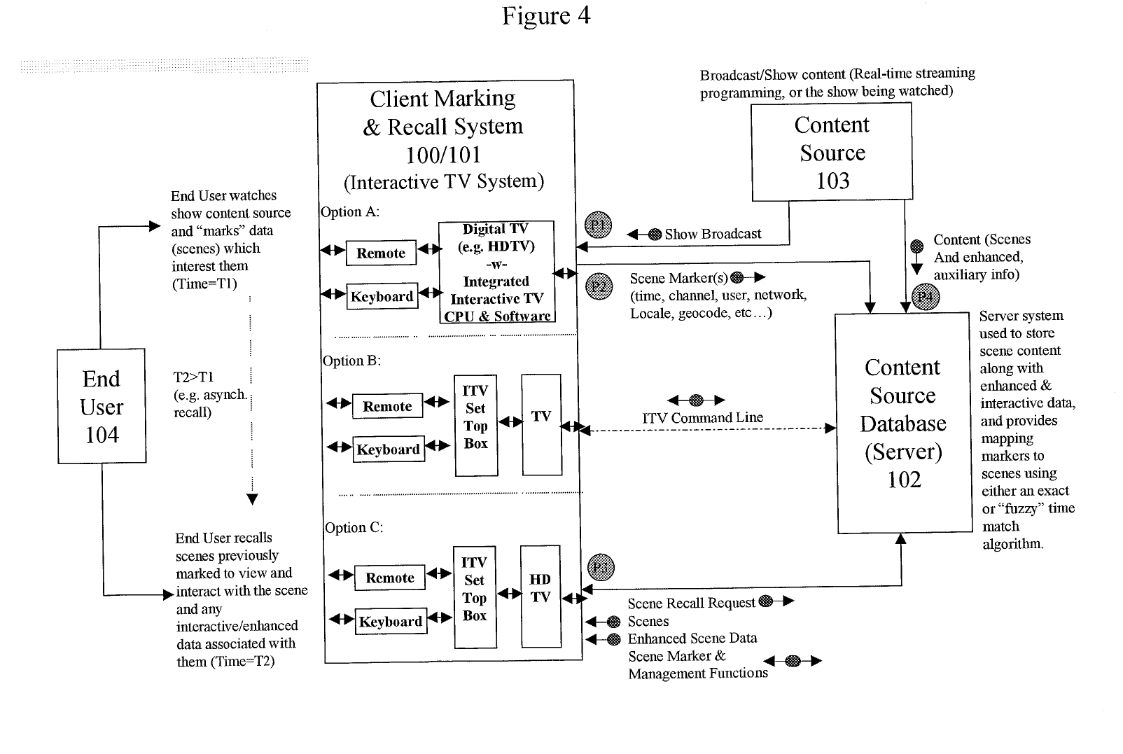

Notwithstanding the forgoing, alternatively, with reference to FIG. 4, client marking system 100 and recall system 101 may be aggregated and/or combined in various fashions and still fall within the scope of the present invention. For example, FIG. 4 illustrates client marking system 100 and recall system 101 embodied in an Interactive TV system. In accordance with various aspects of this embodiment, aggregated system 100/101 might include analog, digital or HDTVs integrated with an Interactive TV CPU and various software and/or ITV set top box, and optionally include various input devices such as keyboards, remotes and the like. The particular operation of the system of FIG. 4 may be selected as desired. Possible operation parameters/alternatives are set forth in further detail in FIG. 4, and thus, will not be described in greater detail in this specification. It should be appreciated, however, that modifications of those possible operation parameters/alternatives as forth therein as is now known or hereafter devised by those skilled in the art are within the scope of this disclosure.

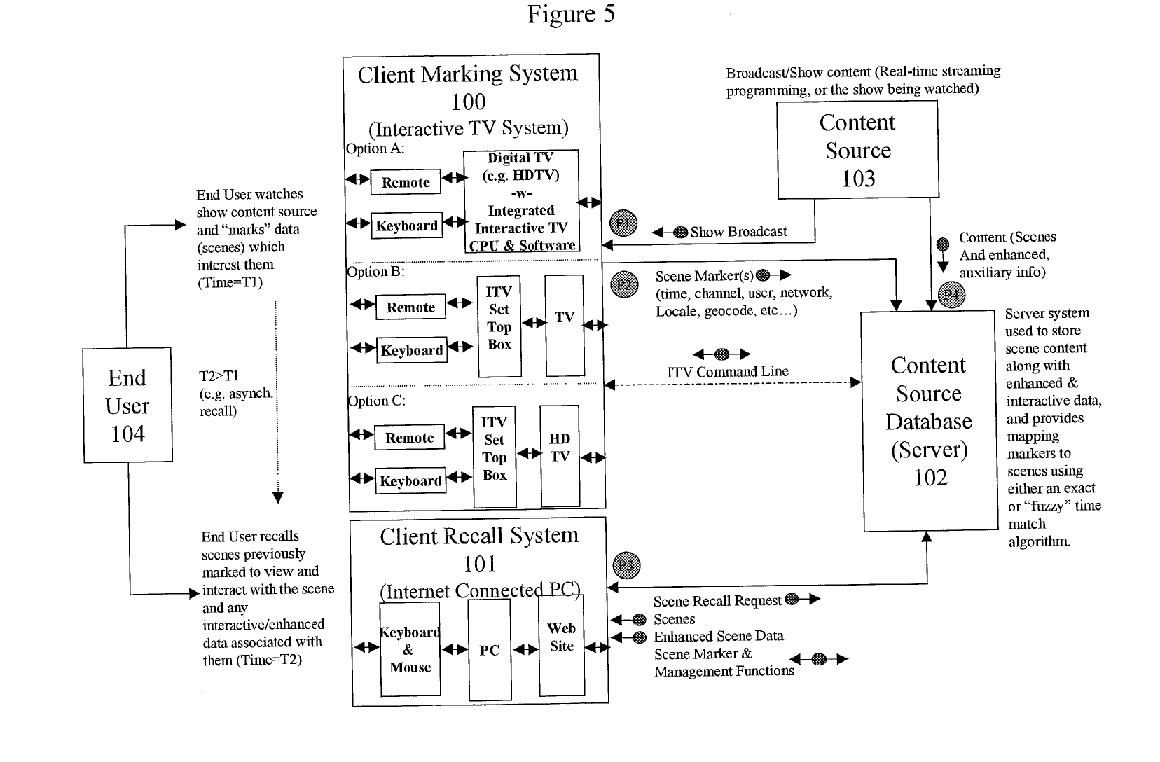

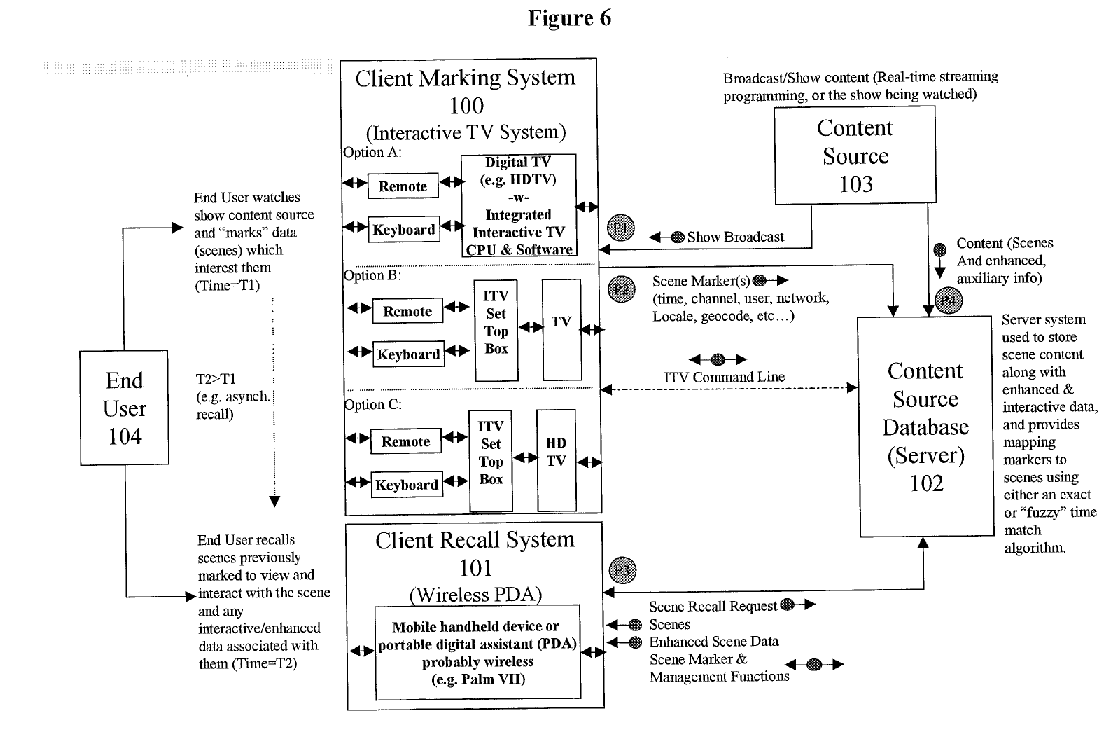

However, with particular reference to FIGS. 5 and 6, client marking system 100 and recall system 101 may be maintained as separate components. For example, FIGS. 5 and 6 illustrate client marking system 100 and recall system 101 as separate components. FIGS. 5 and 6 both illustrate embodiments of the present invention where system 100 comprises various display and data mark devices such as analog, digital or HDTVs integrated with an Interactive TV CPU and various software and/or ITV set top boxes, again, optionally including various input devices such as keyboards, remotes and the like. Separate recall system 101 comprises various remote devices for viewing recalled scenes and/or data. For example, with reference to FIG. 5, recall system 101 may comprise a web site with appropriate connectivity between end user 104, a personal computer and/or a database 102. Alternatively, in accordance with various alternative aspects of the present invention, recall system 101 may comprise other devices for reviewing marked content. Such devices preferably include, for example, wireless devices such as PDAs and cell phones. In accordance further aspects of these embodiments, recall system preferably includes hand held wireless devices.

Again, the particular operation of the system of FIG. 5 may be selected as desired. Possible operation parameters/alternatives are set forth in further detail in FIGS. 5 and 6 and thus, will not be described in greater detail in this specification. It should be appreciated, however, that modifications of those possible operation parameters/alternatives as forth therein as is now known or hereafter devised by those skilled in the art are within the scope of this disclosure.

Thus, the system and methods of the present invention provide a very different user interface from existing interfaces and systems that are currently in use. That is, as illustrated by the exemplary system, this data mark and recall system allows the end user to mark a show scene at any time by pressing a remote button, without stopping or interrupting their viewing of the content. Then, at some later time, at the end user's choice, they can go back to their TV (or other client unit such as a PC, Internet, or PDA) and recall the scene; the system and user model is asynchronous.

The present invention has been described above with reference to an exemplary embodiment. However, changes and modifications may be made to the exemplary embodiment without departing from the scope of the present invention. For example, the various interface devices and communication components may be implemented in alternate ways depending upon the particular application or in consideration of any number of performance criteria associated with the operation of the system. In addition, the techniques described herein are not limited to use. These and other changes or modifications are intended to be included within the scope of the present invention.

We claim:

1. A data mark and recall system, comprising:
a data stream;
a marking system, wherein said marking system notes a particular point in said data stream corresponding to enhanced data content;
a recall system, wherein said recall system allows a user to retrieve said enhanced data content; and
an enhanced content data display.

2. A data mark and recall system in accordance with claim 1, further comprising a storage medium, wherein said marking system creates a stored marker on said storage medium corresponding to said particular point for later recall.

3. A data mark and recall system in accordance with claim 2, further comprising a review system, which allows said user to review said stored marker.

4. A data mark and recall system in accordance with claim 3, wherein said review system is at least one of a television, a computer, a PDA and a cell phone.

5. A data mark and recall system in accordance with claim 1, wherein said data stream is a video stream.

6. A data mark and recall system in accordance with claim 5, wherein said enhanced content comprises a static clip of a video scene corresponding to said particular point in said video stream.

7. A data mark and recall system in accordance with claim 2, wherein said storage medium is located remotely from said user.

8. A data mark and recall system in accordance with claim 2, wherein said storage medium is located locally to said user.

9. A data mark and recall system in accordance with claim 2, wherein said enhanced content is stored on a remote enhanced content database.

10. A data mark and recall system in accordance with claim 2, wherein said enhanced content is stored on a local enhanced content database.

11. A data mark and recall system in accordance with claim 2, wherein said stored marker is data related to a point in time.

12. A data mark and recall system in accordance with claim 2, wherein said stored marker is data related to a predetermined period of time.

13. A data mark and recall system in accordance with claim 2, wherein said stored marker is data related to a temporally closest enhanced content point.

14. A data mark and recall system in accordance with claim 2, wherein said stored marker is data related to a point in time and a source.

15. A data mark and recall system in accordance with claim 14, wherein said stored marker is data further comprising a user identifier.

16. A data mark and recall system in accordance with claim 2, wherein said stored marker is data related to a geographic location of said user.

17. A data mark and recall system in accordance with claim 2, wherein said stored marker is data related to a point in time, a channel and a geographic location of said user.

18. A data mark and recall system in accordance with claim 1, wherein said enhanced content is retrieved asynchronously from said marking.

19. A data mark and recall system in accordance with claim 1, wherein said enhanced content is retrieved synchronously with marking.
